(19) United States
(12) Patent Application Publication
(10) Pub. No.: US 2016/0105494 A1
(43) Pub. Date: Apr. 14, 2016

(54) Fast Fourier Transform Using a Distributed Computing System

(71) Applicant: INTERACTIC HOLDINGS, LLC, Austin, TX (US)

(72) Inventors: Coke S. Reed, Austin, TX (US); Ronald R. Denny, Brooklyn Park, MN (US); Michael R. Ives, Hortonville, WI (US); Terence J. Donnelly, Farmington, MN (US)

(21) Appl. No.: 14/878,127

(22) Filed: Oct. 8, 2015

Related U.S. Application Data
(60) Provisional application No. 62/061,530, filed on Oct. 8, 2014.

(51) Int. Cl. H04L 29/08; G06F 17/14; H04L 12/24

(52) U.S. Cl. CPC H04L 67/10; H04L 41/04; G06F 17/14

(57) ABSTRACT

Techniques are disclosed relating to performing Fast Fourier Transforms (FFTs) using distributed processing. In some embodiments, results of local transforms that are performed in parallel by networked processing nodes are scattered across processing nodes in the network and then aggregated. This may transpose the local transforms and store data in the correct placement for performing further local transforms to generate a final FFT result. The disclosed techniques may allow latency of the scattering and aggregating to be hidden behind processing time, in various embodiments, which may greatly reduce the time taken to perform FFT operations on large input data sets.

This application claims the benefit of U.S. Provisional Application No. 62/061,530, filed on Oct. 8, 2014 which is incorporated by reference herein in its entirety.

### CROSS-REFERENCE TO RELATED PATENTS

The disclosed techniques are related to subject matter disclosed in the following patents and patent applications that are incorporated by reference herein in their entirety:

U.S. Pat. No. 5,996,020 entitled, “A Multiple Level Minimum Logic Network”, naming Coke S. Reed as inventor;

U.S. Pat. No. 6,289,021 entitled, “A Saleable Low Latency Switch for Usage in an Interconnect Structure”, naming John Hesse as inventor;

U.S. Pat. No. 6,754,207 entitled, “Multiple Path Wormhole Interconnect”, naming John Hesse as inventor;

U.S. patent application Ser. No. 11/925,546 entitled, “Network Interface Device for Use in Parallel Computing Systems,” naming Coke Reed as inventor; and

U.S. patent application Ser. No. 13/297,201 entitled “Parallel Information System Utilizing Flow Control and Virtual Channels,” naming Coke S. Reed, Ron Denny, Michael Ives, and Thaine Hock as inventors.

### TECHNICAL FIELD

The present disclosure relates to distributed computing systems, and more particularly to parallel computing systems configured to perform Fourier transforms.

### DESCRIPTION OF THE RELATED ART

The Fourier transform is a well-known mathematical operation used to transform signal between the time domain and the frequency domain. A discrete Fourier transform (DFT) converts a finite list of samples of a function into a finite list of coefficients of complex sinusoids, ordered by their frequencies. Typically, the input and output numbers are equal in number and are complex numbers. Fast Fourier transforms (FFTs) are a set of algorithms used to compute DFTs of N points using at most O(N long N) operations.

FFTs typically break up a transform into smaller transform, e.g., in a recursive manner. Thus, a given transform can be performed starting with multiple two-point transforms, then performing four-point transforms, eight-point transforms, and so on. “Butterfly” operations are used to combine the results of smaller DFTs into a larger DFT (or vice versa). If performing a FFT on inputs in a buffer, butterflies may be applied to adjacent pairs of numbers, then pairs of numbers separated by two, then four, and so on. In multi-processor system, each processor typically works on different pieces of an FFT. Eventually, butterfly operations require results from portions transformed by other processors. Moving and re-arranging data may consume a majority of the processing time for performing an FFT using a multi-processor system.

A typical technique for performing an FFT using a multi-processor system involves the following steps. Consider a multi-processor system that includes K processing nodes. Each node may include one or more processors and/or cores. Initially, the input sequence is stored in a matrix A (e.g., an input sequence of length 2^{2N} may be stored in a 2^{N} by 2^{N} matrix A). The rows of the matrix A are distributed among memories local to K processors (e.g., such that each processor stores roughly 2^{N}/K rows). Each processing node may be a server coupled to a network, e.g., using a blade configuration.

First, each processor transforms each row of its part of the matrix in place, resulting in the overall matrix FA. (These transforms may be referred to as “butterflies” as discussed above, and are well-known, e.g., in the context of the FFTW algorithm).

Second, FA is divided into K² square blocks that each contain data from a single processor. Each block is transposed by the server containing that block to form the overall matrix TA.

Third, the blocks that are not on the diagonal are swapped across the diagonal using a message passing interface among the processors to form the matrix SA.

Fourth, the rows of SA are transformed by each local processor (similarly to the transforms in the first step) to form matrix FFA. Typically, further transposition and/or data movement is required (e.g., the numbers are often stored in bit-reversed order at this point) to generate the desired FFT output.

The steps described above are performed sequentially. The transposition and swapping in the second and third steps of a traditional FFT often consume a majority of the processing time for large input data sets and are often referred to as a “corner turn.” Because processors typically communicate with each other using data portions that the size of cache lines or greater, this rearranging is often causes significant network congestion. Techniques are desired to reduce the impact of corner turns on FFT processing time.

### BRIEF DESCRIPTION OF THE DRAWINGS

A better understanding of the present disclosure can be obtained when the following detailed description is considered in conjunction with the following drawings, in which:

FIG. 1A illustrates an embodiment of a partially populated network interface controller (NIC) and a portion of the off-circuit static random access memory (SRAM) vortex register memory components.

FIG. 1B is a schematic block diagram depicting an example embodiment of a data handling apparatus.

FIG. 2A illustrates an embodiment of formats of two types of packets: 1) a CPAK packet with a 64-byte payload and; 2) a VPAK packet with a 64 bit payload.

FIG. 2B illustrates an embodiment of a lookup first-in, first-out buffer (FIFO) that may be used in the process of accessing remote vortex registers.

FIG. 3 is a diagram illustrating exemplary memory spaces, according to some embodiments.

FIG. 4 is a diagram illustrating exemplary techniques for performing an FFT and exemplary packet movement, according to some embodiments.

FIG. 5 is a diagram illustrating the orientation of data in multiple dimensions for three-pass FFT techniques, according to some embodiments.

FIG. 6 is a flow diagram illustrating a method for performing an FFT, according to some embodiments.

While the disclosure is susceptible to various modifications and alternative forms, specific embodiments thereof are shown by way of example in the drawings and are herein described in detail. It should be understood, however, that the drawings and detailed description thereto are not intended to limit the disclosure to the particular form disclosed, but on the contrary, the intention is to cover all modifications, equivalents and alternatives falling within the spirit and scope of the present disclosure as defined by the appended claims.

The term “configured to” is used herein to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component.

### DETAILED DESCRIPTION

### Terms

The following is a glossary of terms used in the present application:

Memory Medium—Any of various types of non-transitory computer accessible memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program which may be stored in a memory and is executable by a processor or 2) a hardware configuration program useable for configuring a programmable hardware element.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

U.S. patent application Ser. No. 11/925,546 describes an efficient method of interfacing the network to the processor, which is improved in several aspects by the system disclosed herein. In a system that includes a collection of processors and a network connecting the processors, efficient system operation depends upon a low-latency-high-bandwidth processor to network interface.

U.S. patent application Ser. No. 11/925,546 describes an extremely low latency processor to network interface. The system disclosed herein further reduces the processor to network interface latency. A collection of network interface system working registers, referred to herein as vortex registers, facilitate improvements in the system design. The system disclosed herein enables logical and arithmetical operations that may be performed in these registers without the aid of the system processors. Another aspect of the disclosed system is that the number of vortex registers has been greatly increased and the number and scope of logical operations that may be performed in these registers, without resorting to the system processors, is expanded.

The disclosed system enables several aspects of improvement. A first aspect of improvement is to reduce latency by a technique that combines header information stored in the NIC vortex registers with payloads from the system processors to form packets and then inserting these packets into the central network without ever storing the payload section of the packet in the NIC (which may also be referred to as a VIC). A second aspect of improvement is to reduce latency by a technique that combines payloads stored in the NIC vortex registers with header information from the system processors to form packets and then inserting these packets into the central network without ever storing the header section of the packet in the NIC. The two techniques lower latency and increase the useful information in the vortex registers. In U.S. patent application Ser. No. 11/925,546, a large collection of arithmetic and logical units are associated with the vortex registers. In U.S. patent application Ser. No. 11/925,546, the vortex registers may be custom working registers on the chip. The system disclosed herein may use random access memory (SRAM or DRAM) for the vortex registers with a set of logical units associated with each bank of memory, enabling the NIC of the disclosed system to contain more vortex registers than the NIC described in U.S. patent application Ser. No. 11/925,546, thereby allowing fewer logical units to be employed. Therefore, the complexity of each of the logical units may be greatly expanded to include such functions as floating point operations. The extensive list of such program in memory (PIM) operations includes atomic read-modify-write operations enabling, among other things, efficient program control. Another aspect of the system disclosed herein is a new command that creates two copies of certain critical packets and sends the copies through separate independent networks. For many applications, this feature squares the probability of the occurrence of a non-correctable error. A system of counters and flags enables the higher level software to guarantee a new method of eliminating the occurrence of non-correctable errors in other data transfer operations.

### An Overview of NIC Hardware

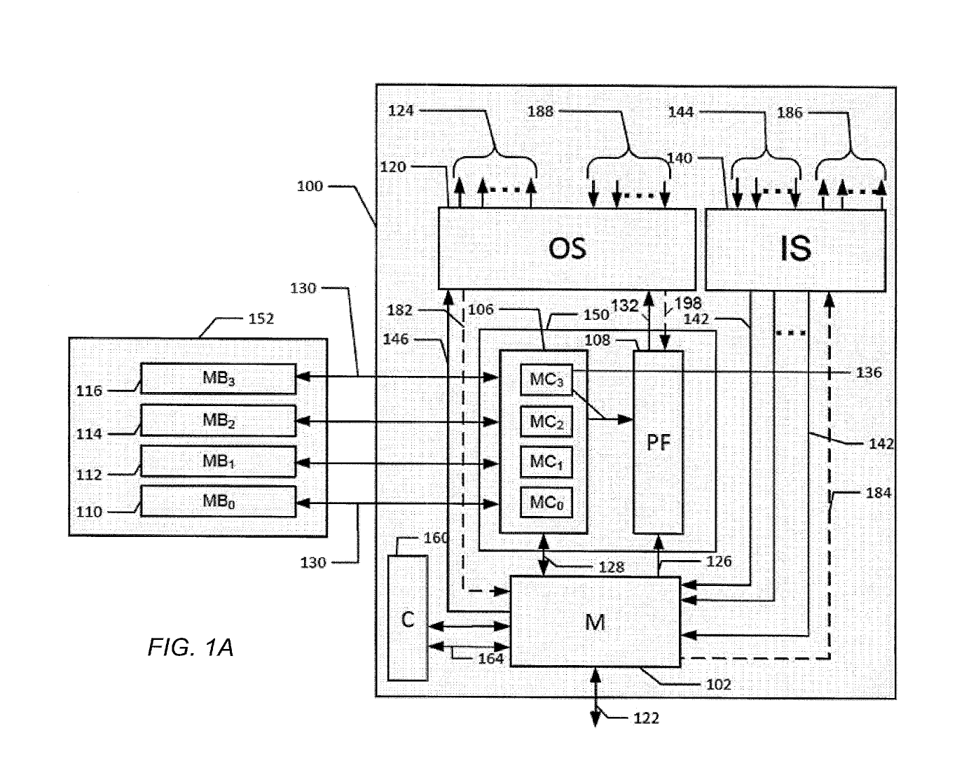

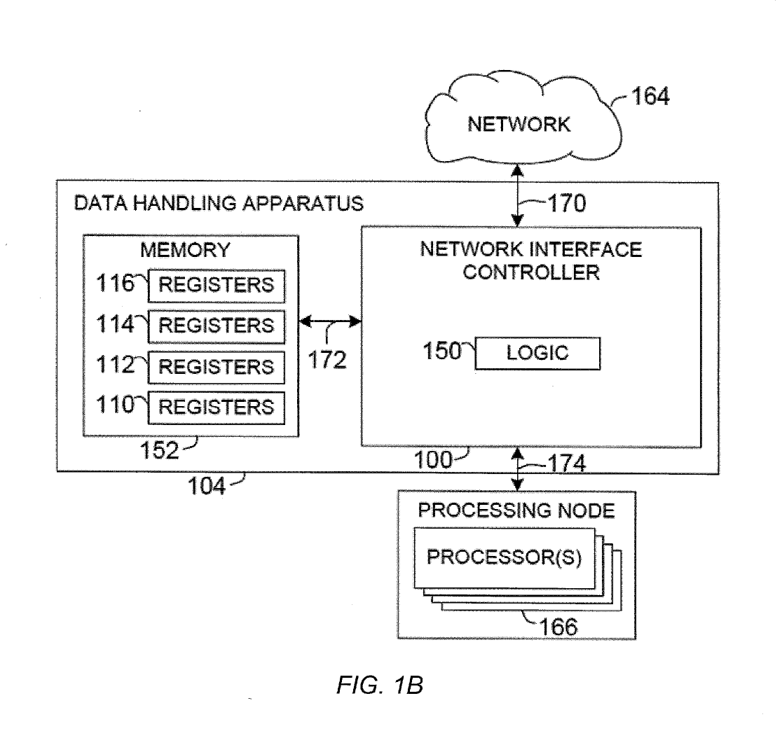

FIG. 1A illustrates components of a Network Interface Controller (NIC) 100 and associated memory banks 152 which may be vortex memory banks formed of data vortex registers. The NIC communicates with a processor local to the NIC and also with Dynamic Random Access Memory (DRAM) through link 122. In some embodiments, link 122 may be a HyperTransport link, in other embodiments, link 122 may be a Peripheral Component Interconnect (PCI) express link. Other suitable links may also be used. The NIC may transfer data packets to central network switches through lines 124. The NIC receives data packets from central network switches through lines 144. Control information is passed on lines 182, 184, 186, and 188. An output switch 120 scatters packets across a plurality of network switches (not shown). An input switch 140 gathers packets from a plurality of network switches (not shown). The input switch then routes the incoming packets into bins in the traffic management module M 102. The processor (not shown) that is connected to NIC 100 is capable of sending and receiving data through line 122. The vortex registers introduced in U.S. patent application Ser. No. 11/925,546 and discussed in detail in the present disclosure are stored in Static Random Access Memory (SRAM) or in some embodiments DRAM. The SRAM vortex memory banks are connected to NIC 100 by lines 130. Unit 106 is a memory controller logic unit (MCLU) and may contain: 1) a plurality of memory controller units; 2) logic to control the flow of data between the memory controllers and the packet-former PF 108; and 3) processing units to perform atomic operations. A plurality of memory controllers located in unit 106 controls the data transfer between the packet former 108 in the NIC and the SRAM vortex memory banks 152. In case a processor PROC is connected to a particular NIC 100 and an SRAM memory bank containing a vortex register VR is also connected to the NIC 100, the vortex register may be defined as and termed a Local Vortex Register of the processor PROC. In case vortex register VR is in an SRAM connected to a NIC that is not connected to the given processor PROC, then vortex register VR may be defined as and termed a Remote Vortex Register of processor PROC. The packet-forming module PF 108 forms a packet by either: 1) joining a header stored in the vortex register memory bank 152 with a payload sent to PF from a processor through link 122 or; 2) joining a payload stored in the vortex register memory bank with a header sent to packet-forming module PF from the processor through links 122 and 126. A useful aspect of the disclosed system is the capability for simultaneous transfer of packets between the NIC 100 and a plurality of remote NICs. These transfers are divided into transfer groups. A collection of counters in a module C 160 keep track of the number of packets in each transfer group that enter the vortex registers in SRAM 152 from remote NICs. The local processor is capable of examining the contents of the counters in module C to determine when NIC 100 has received all of the packets associated with a particular transfer. In addition to forming packets in unit 150, in some embodiments the packets may be formed in the processor and sent to the output switch through line 146.

In an illustrative embodiment, as shown in FIGS. 1A and 1B, a data handling apparatus 104 may comprise a network interface controller 100 configured to interface a processing node 162 to a network 164. The network interface controller 100 may comprise a network interface 170, a register interface 172, a processing node interface 174, and logic 150. The network interface 170 may comprise a plurality of lines 124, 188, 144, and 186 coupled to the network for communicating data on the network 164. The register interface 172 may comprise a plurality of lines 130 coupled to a plurality of registers 110, 112, 114, and 116. The processing node interface 174 may comprise at least one line 122 coupled to the processing node 162 for communicating data with a local processor local to the processing node 162 wherein the local processor 166 may be configured to read data to and write data from the plurality of registers 110, 112, 114, and 116. The logic 150 configured to receive packets comprising a header and a payload from the network 164 and further configured to insert the packets into ones of the plurality of registers 110, 112, 114, and 116 as indicated by the header.

In various embodiments, the network interface 170, the register interface 172, and the processing node interface 174 may take any suitable forms, whether interconnect lines, wireless signal connections, optical connections, or any other suitable communication technique.

In some embodiments, the data handling apparatus 104 may also comprise a processing node 162 and one or more processors 166.

In some embodiments and/or applications, an entire computer may be configured to use a commodity network (such as Infiniband or Ethernet) to connect among all of the processing nodes and/or processors. Another connection may be made between the processors by communicating through a Data Vortex network formed by network interconnect controllers NICs 100 and vortex registers. Thus, a programmer may use standard Message Passing Interface (MPI) programming without using any Data Vortex hardware and use the Data Vortex Network to accelerate more intensive processing loops. The processors may access mass storage through the Infiniband network, reserving the Data Vortex Network for the fine-grained parallel communication that is highly useful for solving difficult problems.

In some embodiments, a data handling apparatus 104 may comprise a network interface controller 100 configured to interface a processing node 162 to a network 164. The network interface controller 100 may comprise a network interface 170, a register interface 172, a processing node interface 174, and a packet-former 108. The network interface 170 may comprise a plurality of lines 124, 188, 144, and 186 coupled to the network for communicating data on the network 164. The register interface 170 may comprise a plurality of lines 130 coupled to a plurality of registers 110, 112, 114, and 116. The processing node interface 174 may comprise at least one line 122 coupled to the processing node 162 for communicating data with a local processor local to the processing node 162 wherein the local processor may be configured to read data to and write data from the plurality of registers 110, 112, 114, and 116. The packet-former 108 may be configured form packets comprising a header and a payload. The packet-former 108 may be configured to use data from the plurality of registers 110, 112, 114, and 116 to form the header and to use data from the local processor to form the payload, and configured to insert formed packets onto the network 164.

In some embodiments and/or applications, the packet-former 108 configured form packets comprising a header and a payload such that the packet-former 108 uses data from the local processor to form the header and uses data from the plurality of registers 110, 112, 114, and 116 to form the payload. The packet-former 108 may be further configured to insert the formed packets onto the network 164.

The network interface controller 100 may be configured to simultaneously transfer a plurality of packet transfer groups.

### Packet Types

At least two classes of packets may be specified for usage by the illustrative NIC system 100. A first class of packets (CPAK packets) may be used to transfer data between the processor and the NIC. A second class of packets (VPAK packets) may be used to transfer data between vortex registers.

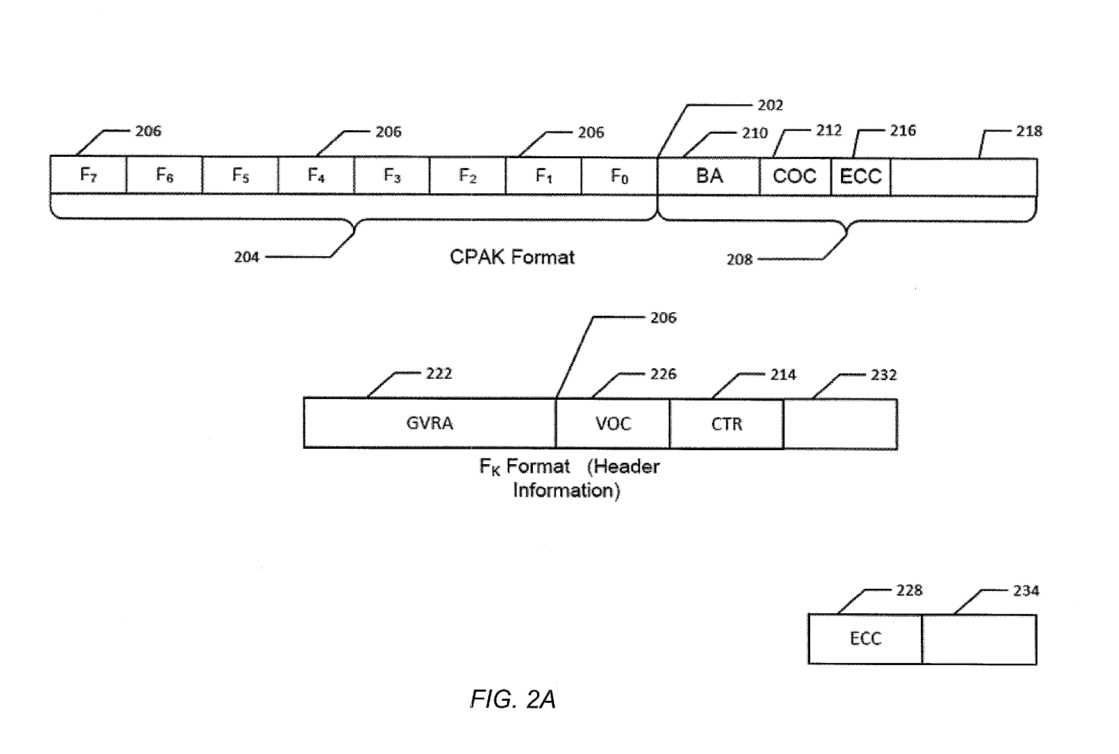

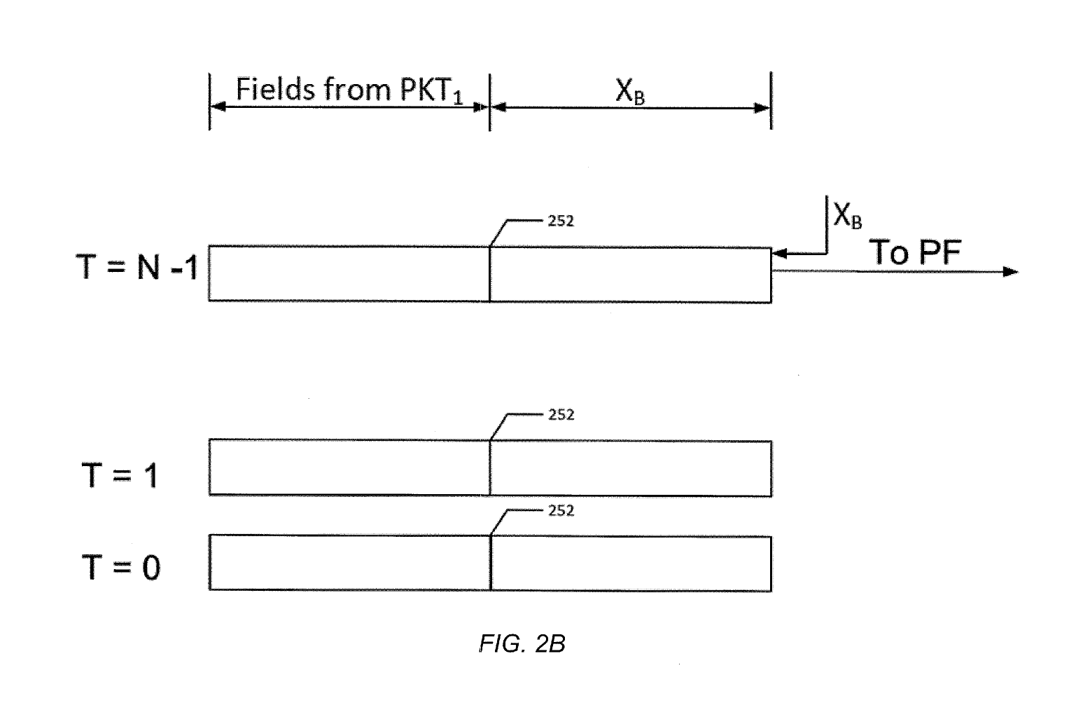

Referring to FIG. 2, embodiments of packet formats are illustrated. The CPAK packet 202 has a payload 204 and a header 208. The payload length of the CPAK packet is predetermined to be a length that the processor uses in communication. In many commodity processors, the length of the CPAK payload is the cache line length. Accordingly, the CPAK packet 202 contains a cache line of data. In illustrative embodiments, the cache line payload of CPAK may contain 64 bytes of data. The payload of such a packet may be divided into eight data fields 206 denoted by F0, F1, . . . , F7. The header contains a base address field BA 210 containing the address of the vortex register designated to be involved with the CPAK packet 202. The header field contains an operation code COC 212 designating the function of the packet. The field CTR 214 is reserved to identify a counter that is used to keep track of packets that arrive in a given transfer. The use of the CTR field is described hereinafter. A field ECC 216 contains error correction information for the packet. In some embodiments, the ECC field may contain separate error correction bits for the payload and the header. The remainder of the bits in the header are in a field 218 that is reserved for additional information. In one useful aspect of the CPAK packet functionality, each of the data fields may contain the payload of a VPAK packet. In another useful aspect of the CPAK packet functionality, each of the data fields FK may contain a portion of the header information of a VPAK packet. When data field FK is used to carry VPAK header information, FK has a header information format 206 as illustrated in FIG. 2. A GVRA field 222 contains the global address of a vortex register that may be either local or remote. The vortex packet OP code denoted by VOC is stored in field 226. A CTR field 214 identifies the counter that may be used to monitor the arrival of packets in a particular transfer group. Other bits in the packet may be included in field 232. In some embodiments, the field 232 bits are set to zero.

Accordingly, referring to FIG. 1A in combination with FIG. 2A, the data handling apparatus 104 may further comprise the local processor (not shown) local to the processing node 162 coupled to the network interface controller 100 via the processing node interface 174. The local processor may be configured to send a packet CPAK 202 of a first class to the network interface controller 100 for storage in the plurality of registers wherein the packet CPAK comprises a plurality of K fields F0, F1, . . . FK−1. Fields of the plurality of K fields F0, F1, . . . FK−1 may comprise a global address GVRA of a remote register, an operation code VOC, and a counter CTR 214 configured to be decremented in response to arrival of a packet at a network interface controller 100 that is local to the remote register identified by the global address GVRA. The first class of packets CPAK 202 specifies usage for transferring data between the local processor and the network interface controller 100.

In some embodiments, one or more of the plurality of K fields F0, F1, . . . FK−1 may further comprise an error correction information ECC 216.

In further embodiments, the packet CPAK 202 may further comprise a header 208 which includes an operation code COC 212 indicative of whether the plurality of K fields F0, F1, . . . FK−1 are to be held locally in the plurality of registers coupled to the network interface controller 100 via the register interface 172.

In various embodiments, the packet CPAK 202 may further comprise a header 208 which includes a base address BA indicative of whether the plurality of K fields F0, F1, . . . FK−1 are to be held locally at ones of the plurality of registers coupled to the network interface controller 100 via the register interface 172 at addresses BA, BA+1, . . . BA+K−1.

Furthermore, the packet CPAK 202 may further comprise a header 208 which includes error correction information ECC 216.

In some embodiments, the data handling apparatus 104 may further comprise the local processor which is local to the processing node 162 coupled to the network interface controller 100 via the processing node interface 174. The local processor may be configured to send a packet CPAK 202 of a first class to the network interface controller 100 via the processing node interface 174 wherein the packet CPAK 202 may comprise a plurality of K fields G0, G1, . . . GK−1, a base address BA, an operation code COC 212, and error correction information ECC 216.

The operation code COC 212 is indicative of whether the plurality of K fields G0, G1, . . . GK−1 are payloads 204 of packets wherein the packet-former 108 forms K packets. The individual packets include a payload 204 and a header 208. The header 208 may include information for routing the payload 204 to a register at a predetermined address.

The second type of packet in the system is the vortex packet. The format of a vortex packet VPAK 230 is illustrated in FIG. 2. In the illustrative example, the payload 220 of a VPAK packet contains 64 bits of data. In other embodiments, payloads of different sizes may be used. In addition to the global vortex register address field GVRA 222 and the vortex OP code field 226, the header also contains the local NIC address LNA 224 an error correction code ECC 228 and a field 234 reserved for additional bits. The field CTR 214 identifies the counter to be used to monitor the arrival of vortex packets that are in the same transfer group as packet 230 and arrive at the same NIC as 230. In some embodiments, the field may be set to all zeros.

The processor uses CPAK packets to communicate with the NIC through link 122. VPAK packets exit NIC 100 through lines 124 and enter NIC 100 through lines 144. The NIC operation may be described in terms of the use of the two types of packets. For CPAK packets, the NIC performs tasks in response to receiving CPAK packets. The CPAK packet may be used in at least three ways including: 1) loading the local vortex registers; 2) scattering data by creating and sending a plurality of VPAK packets from the local NIC to a plurality of NICs that may be either local or remote; and; 3) reading the local vortex registers.

Thus, referring to FIG. 1A in combination with FIG. 2A, the logic 150 may be configured to receive a packet VPAK 230 from the network 164, perform error correction on the packet VPAK 230, and store the error-corrected packet VPAK 230 in a register of the plurality of registers 110, 112, 114, and 116 specified by a global address GVRA 222 in the header 208.

In some embodiments, the data handling apparatus 104 may be configured wherein the packet-former 108 is configured to form a plurality K of packets VPAK 230 of a second type P0, P1, . . . , PK−1 such that for an index W. A packet Pw includes a payload GW and a header containing a global address GVRA 222 of a target register, a local address LNA 224 of the network interface controller 100, a packet operation code 226, a counter CTR 214 that identifies a counter to be decremented upon arrival of the packet Pw, and error correction code ECC 228 that is formed by the packet-former 108 when the plurality K of packets VPAK 230 of the second type have arrived.

In various embodiments, the data handling apparatus 104 may comprise the local processor 166 local to the processing node 162 which is coupled to the network interface controller 100 via the processing node interface 174. The local processor 166 may be configured to receive a packet VPAK 230 of a second class from the network interface controller 100 via the processing node interface 162. The network interface controller 100 may be operable to transfer the packet VPAK 230 to a cache of the local processor 166 as a CPAK payload and to transform the packet VPAK 230 to memory in the local processor 166.

Thus, processing nodes 162 may communicate CPAK packets in and out of the network interface controller NIC 100 and the NIC vortex registers 110, 112, 114, and 116 may exchange data in VPAK packets 230.

The network interface controller 100 may further comprise an output switch 120 and logic 150 configured to send the plurality K of packets VPAK of the second type P0, P1, . . . , PK−1 through the output switch 120 into the network 164.

### Loading the Local Vortex Register Memories

The loading of a cache line into eight Local Vortex Registers may be accomplished by using a CPAK to carry the data in a memory-mapped I/O transfer. The header of CPAK contains an address for the packet. A portion of the bits of the address (the BA field 210) corresponds to a physical base address of vortex registers on the local NIC. A portion of the bits correspond to an operation code (OP code) COC 212. The header may also contain an error correction field 216. Therefore, from the perspective of the processor, the header of a CPAK packet is a target address. From the perspective of the NIC, the header of a CPAK packet includes a number of fields with the BA field being the physical address of a local vortex register and the other fields containing additional information. In an illustrative embodiment, the CPAK operation code (COC 212) set to zero signifies a store in local registers. In an another aspect of an illustrative embodiment, four banks of packet header vortex register memory banks are illustrated. In other embodiments, a different number of SRAM banks may be employed. In an illustrative embodiment, the vortex addresses VR0, VR1, . . . . , VRNMAX−1 are striped across the banks so that VR0 is in MB0110, VR1 is in MB1112, VR2 is in MB2114, VR3 is in MB3 116, VR4 is in MB0 and so forth. To store the sequence of eight 64 bit values in addresses VRN, VRN+1, . . . , VRN+7, a processor sends the cache line as a payload in a packet CPAK to the NIC. The header of CPAK contains the address of the vortex register VRN along with additional bits that govern the operation of the NIC. In case CPAK has a header which contains the address of a local vortex register memory along with an operation code (COC) field set to 0 (the “store operation” code in one embodiment), the payload of CPAK is stored in Local Vortex Register SRAM memory banks.

Hence, referring to FIG. 1A in combination with FIG. 2, the local processor which is local to the processing node 162 may be configured to send a cache line of data locally to the plurality of registers coupled to the network interface controller 100 via the register interface 172.

In some embodiments, the cache line of data may comprise a plurality of elements F0, F1, . . . FN.

CPAK has a header base address field BA which contains the base address of the vortex registers to store the packet. In a simple embodiment, a packet with BA set to N is stored in vortex memory locations VN, VN+1, . . . , VN+7. In a more general embodiment a packet may be stored in J vortex memory locations V[AN], V[AN+B], V[AN+2B], . . . , V[AN+(J−1)B]. with A, B, and J being passed in the field 218.

The processor sends CPAK through line 122 to a packet management unit M 102. Responsive to the OC field set to “store operation”, M directs CPAK through line 128 to the memory controller MCLU 106. In FIG. 1A, a single memory controller is associated with each memory bank. In other applications, a memory controller may be associated with multiple SRAM banks.

In other embodiments, additional op code fields may store a subset of the cache line in prescribed strides in the vortex memories. A wide range of variations to the operations described herein may be employed.

### Reading the Local Vortex Resisters

The processor reads a cache line of data from the Local Vortex Registers VN, VN+1, . . . , VN+7 by sending a request through line 122 to read the proper cache line.

The form of the request depends upon the processor and the format of link 122. The processor may also initiate a direct memory access function DMA that transfers a cache line of data directly to DRAM local to the processor. The engine (not illustrated in FIG. 1A) that performs the DMA may be located in MCLU 106.

### Scattering Data Across the System Using Addresses Stored in Vortex Registers

Some embodiments may implement a practical method for processors to scatter data packets across the system. The techniques enable processors and NICs to perform large corner-turns and other sophisticated data movements such as bit-reversal. After setup, these operations may be performed without the aid of the processors. In a basic illustrative operation, a processor PROC sends a cache line CL including, for example, the eight 64-bit words D0, D1, . . . , D7 to eight different global addresses AN0, AN1, . . . , AN7 stored in the Local Vortex Registers VN, VN+1, . . . , VN+7. In other embodiments, the number of words may not be eight and the word length may not be 64 bits. The eight global addresses may be in locations scattered across the entire range of vortex registers. Processor PROC sends a packet CPAK 202 with a header containing an operation code field, COC 212, (which may be set to 1 in the present embodiment) indicating that the cache line contains eight payloads to be scattered across the system in accordance with eight remote addresses stored in Local Vortex Registers. CPAK has a header base address field BA which contains the base address of VN. In a first case, processor PROC manufactures cache line CL. In a second case, processor PROC receives cache line CL from DRAM local to the processor PROC. In an example embodiment, the module M may send the payload of CPAK and the COC field of CPAK down line 126 to the packet-former PF 108 and may send the vortex address contained in the header of VPAK down line 128 to the memory controller system. The memory controller system 106 obtains eight headers from the vortex register memory banks and sends these eight 64 bit words to the packet-former PF 108. Hardware timing coordinates the sending of the payloads on line 126 and headers on line 136 so that the two halves of the packet arrive at the packet-former at the same time. In response to a setting of 1 for the operation code COC, the packet-former creates eight packets using the VPAK format illustrated in FIG. 2. The field Payload 220 is sent to the packet-former PF 108 in the CPAK packet format. The fields GVRA 222 and VOC 226 are transferred from the vortex memory banks through lines 130 and 136 to the packet-former PF. The local NIC address field (LNA field) 224 is unique to NIC 100 and is stored in the packet-former PF 108. The field CTR 214 may be stored in the FK field in VK. When the fields of the packet are assembled, the packet-former PF 108 builds the error correction field ECC 228.

In another example embodiment, functionality is not dependent on synchronizing the timing of the arrival of the header and the payload by packet management unit M. Several operations may be performed. For example, processor PROC may send VPAK on line 122 to packet management unit M 102. In response to the operation code OC value of 1, packet management unit M sends cache line CL down line 126 to the packetformer, PF 108. Packet-former PF may request the sequence VN, VN+1, . . . , VN+7 by sending a request signal RS from the packet-former to the memory controller logic unit MCLU 106. The request signal RS travels through a line not illustrated in FIG. 1A. In response to request signal RS, memory controller MC accesses the SRAM banks and returns the sequence VN, VN+1, . . . , VN+7 to PF. Packet-former PF sends the sequence of packets (VN,D0), (VN+1,D1), (VN+7,D7) down line 132 to the output switch OS 120. The output switch then scatters the eight packets across eight switches in the collection of central switches. FIG. 1A shows a separate input switch 140 and output switch 120. In other embodiments these switches may be combined to form a single switch.

### Scattering Data Across the System Using Payloads Stored in Vortex Resisters

Another method for scattering data is for the system processor to send a CPAK with a payload containing eight headers through line 122 and the address ADR of a cache line of payloads in the vortex registers. The headers and payloads are combined and sent out of the NIC on line 124. In one embodiment, the OP code for this transfer is 2. The packet management unit M 102 and the packet-former PF 108 operate as before to unite header and payload to form a packet. The packet is then sent on line 132 to the output switch 120.

### Sending Data Directly to a Remote Processor

A particular NIC may contain an input first-in-first-out buffer (FIFO) located in packet management unit M 102 that is used to receive packets from remote processors. The input FIFO may have a special address. Remote processors may send to the address in the same manner that data is sent to remote vortex registers. Hardware may enable a processor to send a packet VPAK to a remote processor without pre-arranging the transfer. The FIFO receives data in the form of 64-bit VPAK payloads. The data is removed from the FIFO in 64-byte CPAK payloads. In some embodiments, multiple FIFOs are employed to support quality-of-service (QoS) transfers. The method enables one processor to send a “surprise packet” to a remote processor. The surprise packets may be used for program control. One useful purpose of the packets is to arrange for transfer of a plurality of packets from a sending processor S to a receiving processor R. The setting up of a transfer of a specified number of packets from S to R may be accomplished as follows. Processor S may send a surprise packet to processor R requesting that processor R designates a block of vortex registers to receive the specified number of packets. The surprise packet also requests that processor R initializes specified counters and flags used to keep track of the transfer. Details of the counters and flags are disclosed hereinafter.

Accordingly, referring to FIG. 1A, the network interface controller 100 may further comprise a first-in first-out (FIFO) input device in the packet management unit M 102 such that a packet with a header specifying a special GVRA address causes the packet to be sent to the FIFO input device and the FIFO input device transfers the packet directly to a remote processor specified by the GVRA address.

### Packets Assembled by the Processor

Sending VPAK packets without using the packet-former may be accomplished by sending a CPAK packet P from the processor to the packet management unit M with a header that contains an OP code indicating whether the VPAK packets in the payload are to be sent to local or remote memory. In one embodiment, the header may also set one of the counters in the counter memory C. By this procedure, a processor that updates Local Vortex Registers has a method of determining when that process has completed. In case the VPAK packets are sent to remote memory, the packet management unit M may route the said packets through line 146 to the output switch OS.

### Gathering the Data

In the following, a “transfer group” may be defined to include a selected plurality of packet transfers. Multiple transfer groups may be active at a specified time. An integer N may be associated with a transfer group, so that the transfer group may be specified as “transfer group N.” A NIC may include hardware to facilitate the movement of packets in a given transfer group. The hardware may include a collection of flags and counters (“transfer group counters” or “group counters”).

Hence, referring to FIG. 1A in combination with FIG. 2A, the network interface controller 100 may further comprise a plurality of group counters 160 including a group with a label CTR that is initialized to a number of packets to be transferred to the network interface controller 100 in a group A.

In some embodiments, the network interface controller 100 may further comprise a plurality of flags wherein the plurality of flags are respectively associated with the plurality of group counters 160. A flag associated with the group with a label CTR may be initialized to zero the number of packets to be transferred in the group of packets. [0062] In various embodiments and/or applications, the plurality of flags may be distributed in a plurality of storage locations in the network interface controller 100 to enable a plurality of flags to be read simultaneously.

In some embodiments, the network interface controller 100 may further comprise a plurality of cache lines that contain the plurality of flags.

The sending and receiving of data in a given transfer group may be illustrated by an example. In the illustrative example, each node may have 512 counters and 1024 flags. Each counter may have two associated flags including a completion flag and an exception flag. In other example configurations, the number of flags and counters may have different values. The number of counters may be an integral multiple of the number of bits in a processor's cache line in an efficient arrangement.

Using an example notation, the Data Vortex® computing and communication device may contain a total of K NICs denoted by NIC0, NIC1, NIC2, . . . , NICK−1. A particular transfer may involve a plurality of packet-sending NICs and also a plurality of packet-receiving NICs. In some examples, a particular NIC may be both a sending NIC and also a receiving NIC. Each of the NICS may contain the transfer group counters TGC0, TGC1, . . . , TGC511. The transfer group counters may be located in the counter unit C 160. The timing of counter unit C may be such that the counters are updated after the memory bank update has occurred. In the illustrative example, NICJ associated with processor PROCJ may be involved in a number of transfer groups including the transfer group TGL. In transfer group TGL, NICJ receives NPAK packets into pre-assigned vortex registers. The transfer group counter TGCM on NICJ may be used to track the packets received by NICJ in TGL. Prior to the transfer: 1) TGCM is initialized to NPAK−1; 2) the completion flag associated with TGCM is set to zero; and 3) the exception flag associated with TGCM is set to zero. Each packet contains a header and a payload. The header contains a field CTR that identifies the transfer group counter number CN to be used by NICJ to track the packets of TGL arriving at NICJ. A packet PKT destined to be placed in a given vortex register VR in NICJ enters error correction hardware. In an example embodiment, the error correction for the header may be separate from the error correction for the payload. In case of the occurrence of a correctable error in PKT, the error is corrected. If no uncorrectable errors are contained in PKT, then the payload of PKT is stored in vector register VR and TGCCN is decremented by one. Each time TGCCN is updated, logic associated with TGCCN checks the status of TGCCN. When TGCM is negative, then the transfer of packets in TGL is complete. In response to a negative value in TGCCN, the completion flag associated with TGCCN is set to one.

Accordingly, the network interface controller 100 may further comprise a plurality of group counters 160 including a group with a label CTR that is initialized to a number of packets to be transferred to the network interface controller 100 in a group A. The logic 150 may be configured to receive a packet VPAK from the network 164, perform error correction on the packet VPAK, store the error-corrected packet VPAK in a register of the plurality of registers 110, 112, 114, and 116 as specified by a global address GVRA in the header, and decrement the group with the label CTR.

In some embodiments, the network interface controller 100 may further comprise a plurality of flags wherein the plurality of flags are respectively associated with the plurality of group counters 160. A flag associated with the group with a label CTR may be initialized to zero the number of packets to be transferred in the group of packets. The logic 150 may be configured to set the flag associated with the group with the label CTR to one when the group with the label CTR is decremented to zero.

The data handling application 104 may further comprise the local processor local to the processing node 162 coupled to the network interface controller 100 via the processing node interface 174. The local processor may be configured to determine whether the flag associated with the group with the label CTR is set to one and, if so, to indicate completion of transfer.

In case an uncorrectable error occurs in the header of PKT, then TGCCN is not modified, neither of the flags associated with TGCCN is changed, and no vortex register is modified. If no uncorrectable error occurs in the header of PKT, but an uncorrectable error occurs in the payload of PKT, then TGCCN is not modified, the completion flag is not modified, the exception flag is set to one, no vortex register is modified, and PKT is discarded.

The cache line of completion flags in NICJ may be read by processor PROCJ to determine which of the transfer groups have completed sending data to NICJ. In case one of the processes has not completed in a predicted amount of time, processor PROCJ may request retransmission of data. In some cases, processor PROCJ may use a transmission group number and transmission for the retransmission. In case a transmission is not complete, processor PROCJ may examine the cache line of exception flags to determine whether a hardware failure associated with the transfer.

### Transfer Completion Action

A unique vortex register or set of vortex registers at location COMPL may be associated with a particular transfer group TGL. When a particular processor PROCJ involved in transfer group TGL determines that the transfer of all data associated with TGL has successfully arrived at NICL, processor PROCJ may move the data from the vortex registers and notify the vortex register or set of vortex registers at location COMPL that processor PROCJ has received all of the data. A processor that controls the transfer periodically reads COMPL to enable appropriate action associated with the completion of the transfer. A number of techniques may be used to accomplish the task. For example, location COMPL may include a single vortex register that is decremented or incremented. In another example location COMPL may include a group of words which are all initialized to zero with the Jth zero being changed to one by processor PROCJ when all of the data has successfully arrived at processor PROCJ, wherein processor PROCJ has prepared the proper vortex registers for the next transfer.

### Reading Remote Vortex Resisters

One useful aspect of the illustrative system is the capability of a processor PROCA on node A to transfer data stored in a Remote Vortex Register to a Local Vortex Register associated with the processor PROCA. The processor PROCA may transfer contents XB of a Remote Vortex Register VRB to a vortex register VRA on a node A by sending a request packet PKT1 to the address of VRB, for example contained in the GRVA field 222 of the VPAK format illustrated in FIG. 2. The packet PKT1 containing the address of vortex register VRA in combination with a vortex operation code set to the predetermined value to indicate that a packet PKT2 which has a payload holding the content of vortex register VRB may be created and sent to the vortex register VRA. The packet PKT1 may also contain a counter identifier CTR that indicates which counter on node A is to be used for the transfer. The packet PKT1 arrives at the node B NIC 100 through the input switch 140 and is transported through lines 142 and 128 to the memory controller logic unit MCLU 106. Referring to FIG. 2B, a lookup FIFO (LUF) 252 is illustrated. In response to the arrival of packet PKT1, an MCLU memory controller MCK places the packet PKT1 in a lookup FIFO (LUF 252) and also requests data XB from the SRAM memory banks. A time interval of length DT is interposed from the time that MCK requests data XB from the SRAM until XB arrives at MCLU 106. During the time interval DT, MCK may make multiple requests for vortex register contents, in request packets that are also contained in the LUF-containing packet PKT1. The LUF contains fields having all of the information used to construct PKT2 except data XB. Data XB arrives at MCLU and is placed in the FIFO-containing packet PKT1. The sequential nature of the requests ensures proper placement of the returning packets. All of the data used to form packet PKT2 are contained in fields alongside packet PKT1. The MCLU forwards data XB in combination with the header information from packet PKT1 to the packet-former PF 108 via line 136. The packet-former PF 108 forms the vortex packet PKT2 with format 230 and sends the packet through output switch OS to be transported to vortex register VRA.

In the section hereinabove entitled “Scattering data across the system using payloads stored in vortex registers,” packets are formed by using header information from the processor and data from the vortex registers. In the present section, packets are formed using header information in a packet from a remote processor and payload information from a vortex register.

### Sending Multiple Identical Packets to the Same Address

The retransmission of packets in the case of an uncorrectable error described in the section entitled “Transfer Completion Action” is an effective method of guaranteeing error free operation. The NIC has hardware to enable a high level of reliability in cases in which the above-described method is impractical, for example as described hereinafter in the section entitled, “Vortex Register PIM Logic.” A single bit flag in the header of request packet may cause data in a Remote Vortex Register to be sent in two separate packets, each containing the data from the Remote Vortex Register. These packets travel through different independent networks. The technique squares the probability of an uncorrectable error.

### Exemplary FFT Processing Techniques

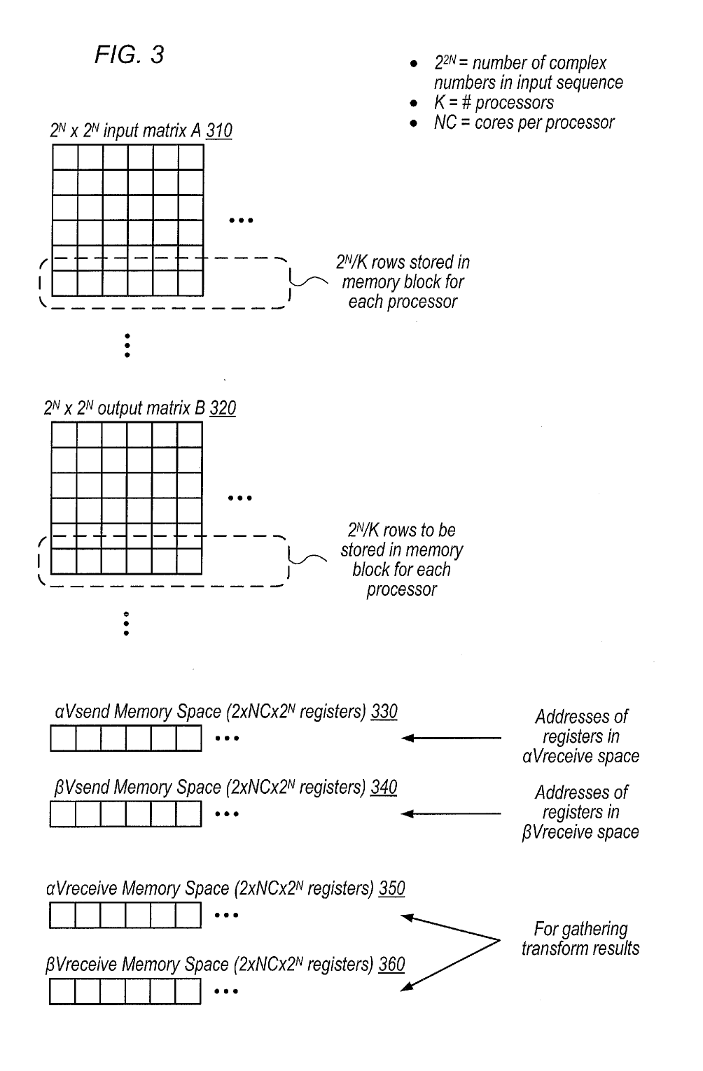

FIG. 3 shows multiple memory spaces used to set up an FFT according to some embodiments. In the illustrated embodiment, a memory space 310 is used to store input matrix A, which is a 2^{N} by 2^{N} matrix configured to store the 2^{2N} complex-valued numbers in an input sequence. In various embodiments, the input sequence may be broken into more dimensions based on the size of the FFT; the two-dimensional matrix is included for illustrative purposes and is not intended to limit the scope of the present disclosure.

Memory space 320, in the illustrated embodiment, is reserved for an output matrix B for storing results of an FFT on matrix A. As shown in the illustrated embodiment, the matrix A is stored so that the bottom 2^{N}/K rows of the matrix are stored in local memory on a processing node that includes processor P₀ (e.g., in DRAM in some embodiments), the next 2^{N}/K rows are stored in the memory block associated with P₁ and so forth so that the top 2^{N}/K rows are stored in the memory block associated with processor P_{K-1}. In the illustrated embodiment, the matrix B is spread out among the local memories of the processors in the same manner as A with the bottom 2^{N}/K rows of B stored local to the processor in processing node S₀. The next 2^{N}/K rows of B are associated with processing node S₁ and so forth so that the top 2^{N}/K rows of BV are in memory associated with S_{K-1}.

In some embodiments, the Data Vortex computer includes K processing nodes S₀, S₁, . . . , S_{K-1} in a number of servers with each server consisting of a number of processors and associated local memory. In some embodiments, each processor is configured to perform NC transforms in parallel (for example, each core may contain NC cores configured to perform operations in parallel, be multithreaded or SIMD cores configured to perform NC operations in parallel, etc. In some embodiments, the FFT process involves performing 2^{N} transforms in each dimension on an input sequence with 2^{N} elements.

In some embodiments, memory spaces 330, 340, 350, and 360 are allocated in memory modules 152 of different processing nodes. In some embodiments, this is in SRAM and each location contains 64 bits of data. In the illustrated embodiment, each of these memory blocks contains (2×NC×2^{N}) memory locations that are each configured to store 64 bits, such that each block is configured to store NC×2^{N} complex numbers.

In some embodiments, the αVsend and βVsend, vortex memory blocks are pre-loaded with addresses of memory locations in memory modules 152 of remote processing nodes. In some embodiments, these locations are loaded once and then are maintained without changing for the remainder of the FFT process. In some embodiments, the αVreceive and βVreceive memory spaces 350 and 360 are used to aggregate scattered packets to facilitate one or more transpose operations during an FFT. In some embodiments, completion group counters are used to determine when to store data based on these addresses.

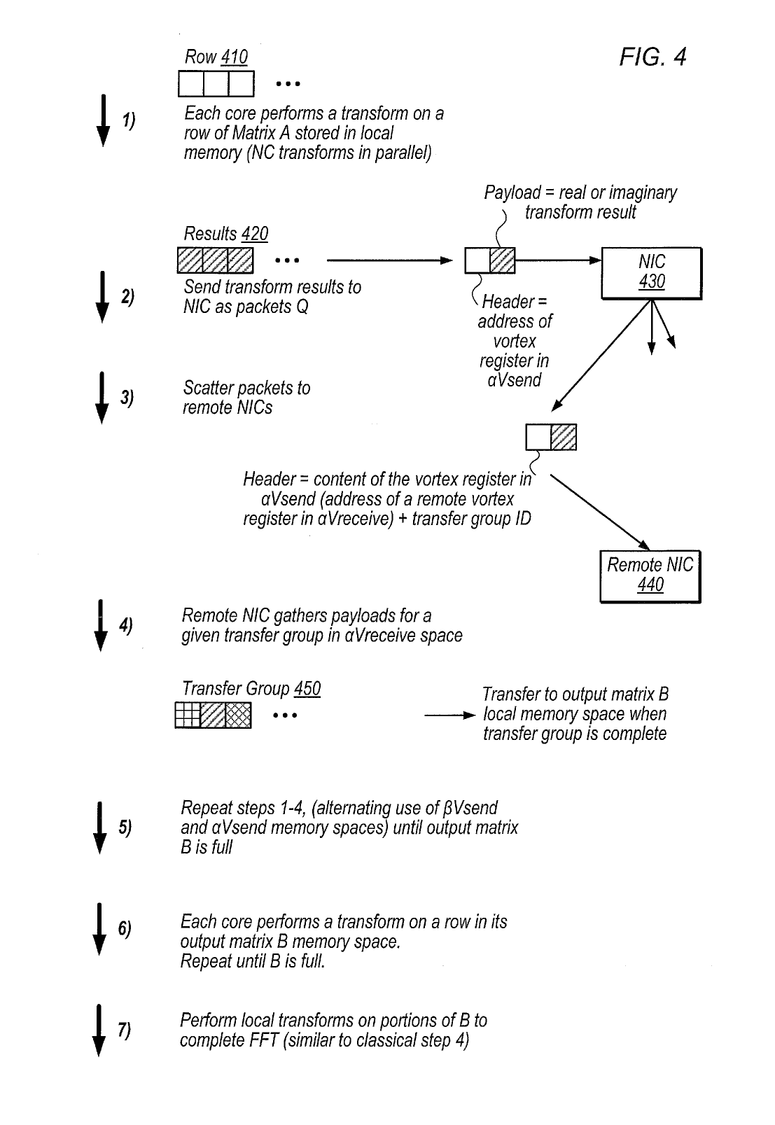

In the first step of the FFT, in some embodiments, each processor P performs NC transforms with each transform being performed on a row of complex numbers in that portion of A that is local to P. This is shown as step 1) in FIG. 4 on row 410. The NC transforms are performed in parallel with each core performing one of the transforms, in some embodiments. As soon as a core of a given processor has completed its transform, it sends the results in packets Q to the processor VIC of processor P, shown as results 420 in FIG. 4. In some embodiments, packets Q are CPAK packets. The header of one of these packets contains an address ADR of local NIC memory 152 and also contains an OP code. The payloads of a given packet consist of a real or an imaginary number from the transformed row, in some embodiments. Responsive to the reception of one of these packets packet, the VIC constructs new packets, NP whose header is the contents of ADR and whose payload is one of the payloads PL of the packet Q. These packets are VPAC packets, in some embodiments. Following the construction of these packets, the VIC sends the NP packets to the remote VIC memory at addresses indicated by the contents of ADR. This address is in the αVreceive memory space. This process results in the scattering of (2×NC×2^{N}) packets across the global vortex memory space from local NIC 430 to various remote NICs 440 (while local NIC 430 may similarly receive packets scattered from other NICs). The preloading of the VIC memories is such that every pair of processors P_{U} with VIC_{U} and Pᵥ with VIC_{V}, there are NC addresses of VIC_{V} memory that are stored in VIC_{U} memory with no common VIC address stored in two VIC memories, in some embodiments. Moreover, each VIC memory will receive (2×NC×2^{N}) packets, in some embodiments. This gather-scatter operation consisting of a group of transfers between VIC memories is referred to as a transfer group. Associated with this first transfer, is the transfer group referred to as number 0. On each NIC there is a collection of group counters, as described above in various embodiments. Group counter 0 on each VIC is set to (2×NC×2^{N}), the number of packets that it will receive in the transfer. Each time that a packet in transfer group 0 arrives at a VIC, the group counter 0, is decremented so that when all of the packets in group 0, group counter 0 will contain the value of 0. This may synchronize transfers across the system.

In some embodiments, when the group counter of a given VIC associated with a processor P_{U} reaches 0, the VIC is configured to set off a DMA transfer or transfer data using CPAK packets to the B memory space. The transfer of data into B memory space will fill up the leftmost NC columns of B (columns 0, 1, . . . NC−1), in these embodiments.

This is shown in step 4) of the illustrated embodiment of FIG. 4. The determination of which portion of the B memory space to fill using aggregated groups of packets may be made based on a count of the number of completion groups received, in some embodiments.

In some embodiments, in the next step of the process, each processor performs NC transforms on rows NC, NC+1, . . . , 2NC−1 of the A matrix and scatter the results into βVreceive memory blocks. This transfer will use group counter 1 in each VIC. When this transfer is complete, the contents of βVreceive will be transferred to columns NC, NC+1, . . . , 2NC−1.

In some embodiments, the group counter associated with the αVreceive memory block is reset to (2×NC×2^{N}) after the counter reaches zero, so that it can be re-used.

As shown in step 5) of FIG. 4, the transforms and scattering may be iteratively performed alternating use of the βVreceive and αVreceive memory blocks until the B memory space is full of transformed values. Alternating use of these spaces may hide the transfer latency such that the processors are always able to perform transforms instead of waiting for data transfers over the network. In other embodiments, any of various numbers of different send and receive memory spaces may be set up to hide the latency (e.g., a γVreceive may be used, and so on).

Notice that the αVsend and βVsend blocks in the VIC memory spaces remain constant throughout the process. There exist αVsend and βVsend memory blocks that result in a matrix B that is equal to the matrix SA produced in step three of the classic algorithm. This has the interesting consequence that the disclosed techniques performs the local transpose and the global corner turn in a single step. Moreover, the processors are not involved in this step. The transpose may allow the processors to work on the data stored in linear order for subsequent transforms and further may enable all required data to fill cache lines in the order that they will be used, for efficient processing. Moreover, the movement of data from A to B can be done simultaneously with the transforming of data in A.

In the illustrated embodiment of FIG. 4, once the B memory space is full, local transforms are performed on B to complete the FFT operation.

Note that, in various disclosed embodiments, processors and NICs may be separate, coupled computing devices. In other embodiments, NIC 100 may be included on the same integrated circuit as one or more processors of a given processing node. As used herein, the term “processing node” refers to a computing element configured to couple to a network that include at least one processor and a network interface. The network may couple a plurality of NICs 100 and corresponding processors, which may be separate computing devices or included on a single integrated circuit, in various embodiments. The network packets that travel between the NICs 100 may be fine grained, e.g., may contain 64-bit payloads in some embodiments. These may be referred to as VPAC packets. In some embodiments, memory banks 152 are SRAM, and each SRAM address indicates a location that contains data corresponding in size to a VPAC payload (e.g., 64 bits). CPAK packets may be used to transfer data between a network interface and a processor cache or memory and may be large enough to include multiple VPAC payloads.

### Exemplary Multi-Pass Techniques

The previous section described a Discrete Fourier Transform performed on a sequence of length 2^{2N} by performing 2×2^{N} FFTs on complex number sequences of length 2^{N}. In the present section, a complex number sequence u=u(0), u(1), . . . , u(2^{3N}−1) will be transformed by performing 3×2^{2N} FFTs on complex number sequences of length J where J=2^{N}. In the present three pass algorithm, members of u are located in a three dimensional matrix A (cube) of size 2^{N}×2^{N}×2^{N}. The cube is situated with one corner at (0,0,0), one edge on the x-axis, one edge on the y-axis and one edge on the z-axis. If u(a) and u(b) are two elements of u at distance one apart on the x-axis, then |a−b|=1. If u(a) and u(b) are two elements of u at distance one apart on the y-axis, then |a−b|=2^{N}. If u(a) and u(b) are two elements of u at distance one apart on the z-axis, then |a−b|=2^{2N}.

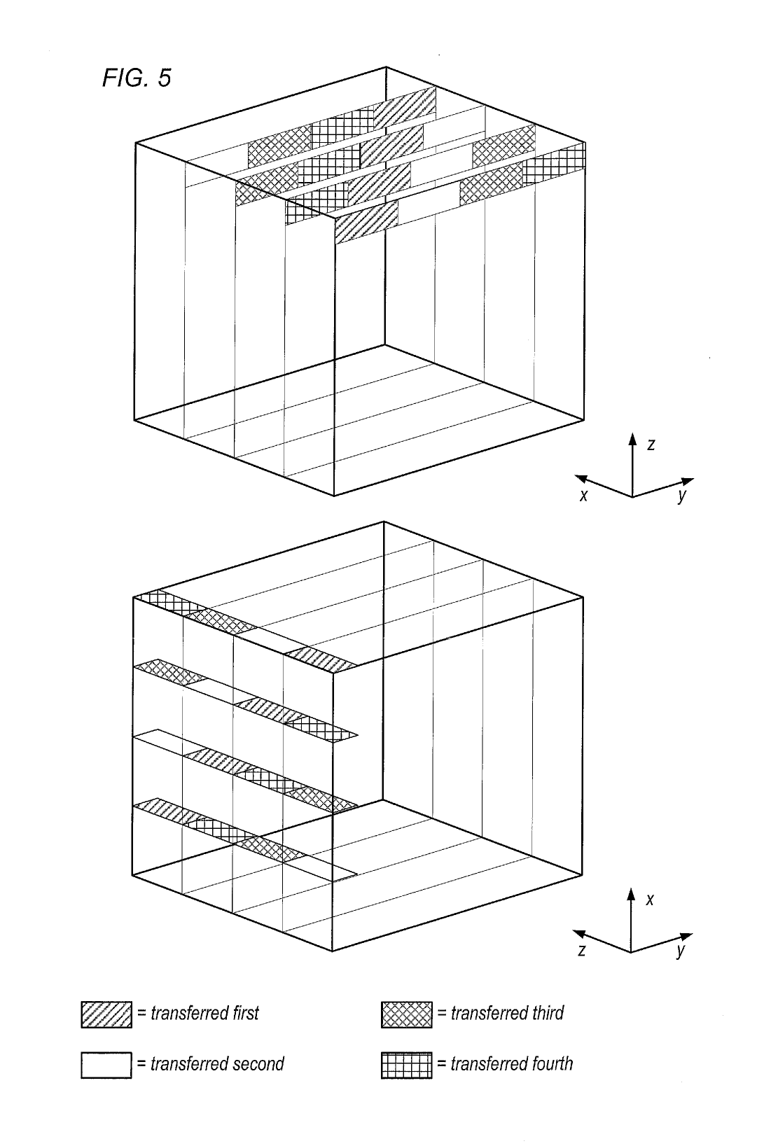

As in the last section, the Data Vortex computer may include of K processors P₀, P₁, . . . , P_{K-1} in a number of servers with each server consisting of a number of processors and associated local memory. Each of the data elements of u lies on a plane that is parallel to the plane PYZ containing the y and z axis. There are 2^{N} such planes. The 2^{N}/K planes closest to PYZ are in the local memory of P₀, the next 2^{N}/K planes are in the local memory of P₁ and so forth. This continues so that the 2^{N}/K planes at greatest distance from PYZ are in the local memory of processor P_{K-1}. The processing techniques may proceed as described above in the two dimensional case. Each VIC αVsend and βVsend memory blocks are loaded with addresses in the αVreceive, and βVreceive memory blocks. Consider the set Δ consisting of 2^{N} long subsequences of u that lie on lines parallel to the z-axis. Each member of Δ lies in the local memory of a processor. Now, just as in the two dimensional case, the processors perform FFTs on all of the members of Δ. As the transforms are performed, the data is moved using the VIC memory blocks αVsend, βVsend, αVreceive, and βVreceive and the VIC DMA engine. In the two dimensional case the data was moved using a corner turn of a two dimensional matrix. In the three dimensional case, the data is moved using a corner turn of a three dimensional matrix. An example of this is shown in FIG. 5. At the end of this data movement, the data is positioned so that the so that the 2^{N} long lines that are now parallel to the z-axis are those lines that are now ready to transform. Each of these 2^{N} long subsets of u are now transformed and then repositioned using the VIC memory blocks αVsend, βVsend, αVreceive, and βVreceive and the VIC DMA engine. This data is then transformed and repositioned for the final transform. In various embodiments, FFTs may be performed using various numbers of passes or dimensions. In various embodiments, the number of elements in each pass or dimension may or may not be equal (e.g., smaller FFTs may be performed for a given pass or dimension). The FFTs may truly be higher-dimensional FFTs, or 2-dimensional FFTs may be performed using multiple passes by storing the data as if it were for a higher-dimensional FFT.

In the classical parallel algorithm, the steps of performing the FFTs, local transposition, and global transposition across the diagonal are performed as three sequential steps. In the algorithms disclosed herein, the local and global transpositions are performed in a single step, moreover the well-known additional step of un-doing the bit reversal can be incorporated into the single data movement step performed by the Data Vortex VIC hardware. Also notice that the data movement step does not involve the processor. Therefore, relieved of any data movement duties, the processors can spend all of their time performing transforms. On some embodiments, the data movement portion of the algorithm requires less time than the FFT portion of the algorithm and therefore, except for the last (α,β) passes this work is completely hidden.

The efficiency of a single processor FFT often depends on the size of the transform. Transforms that are small enough to fit in level one cache can typically be performed more efficiently than larger transforms. A key motivation for using a greater number of passes instead of the two pass algorithm may be to make it possible for the local transforms to fit in level one cache. Another reason for using the three pass algorithm is that it makes it possible to fit the αVsend, βVsend, αVreceive, and βVreceive memory blocks in the VIC memory space. For increasingly large input data sets, it may be necessary to use an N pass algorithm that is a natural extension of the two pass and three pass algorithms disclosed herein.

Therefore, in some embodiments, the computing system is configured to receive a set of input data to be transformed and determine a number of passes for the transform based on the size of the input data. In some embodiments, this determination is made such that the portion of the input data to be transformed by each processing node for each pass is small enough to fit in a low-level cache of the processing node. In some embodiments, this determination is made such that the memory blocks for holding remote addresses are small enough to fit in a memory module 152 for scattering packets across the network.

### Exemplary Method

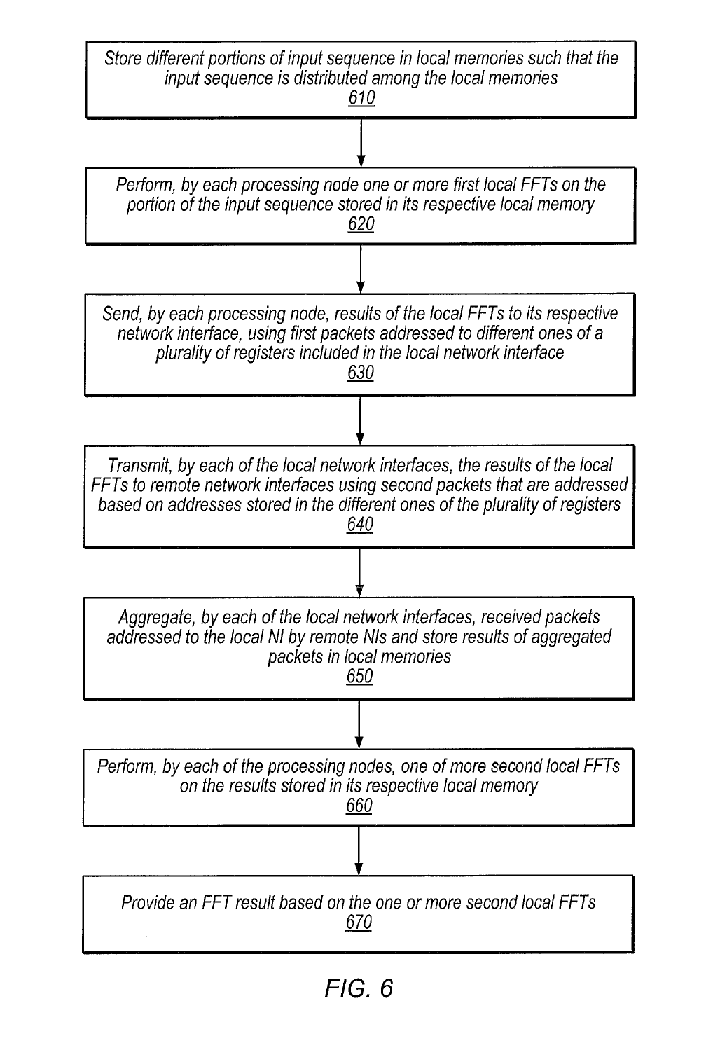

FIG. 6 is a flow diagram illustrating a method for performing an FFT, according to some embodiments. The method shown in FIG. 6 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. Flow begins at 610.

At 610, in the illustrated embodiment, different portions of an input sequence are stored in local memories such that the input sequence is distributed among the local memories. In the example of FIG. 3, this may involve distributing the A matrix across multiple processing nodes.

At 620, in the illustrated embodiment, each processing node performs one or more first local FFTs on the portion of the input sequence stored in its respective local memory. This may correspond to step 1) in the example of FIG. 4. The local transforms may be performed in parallel by multiple cores or threads of the processing nodes. Results of the local transforms may need to be transposed before performing further transforms to generate an FFT result.

At 630, in the illustrated embodiment, each processing node sends results of the local FFTs to its respective network interface, using first packets addressed to different ones of a plurality of registers included in the local network interface (e.g., to registers in memory 152). This may correspond to step 2) in the example of FIG. 4. These registers may be implemented using a variety of different memory structures and may each be configured to store a single real or imaginary value from the input sequence (e.g., 64-bit value), in some embodiments. In various embodiments, each value from the input sequence may be stored using any appropriate number of bits, such as 32, 128, etc.

At 640, in the illustrated embodiment, each network interface transmits the results of the local FFTs to remote network interfaces using second packets that are addressed based on addresses stored in the different ones of the plurality of registers. This scatters the results across the processing nodes, in some embodiments, to transpose the result of the first local FFTs.

At 650, in the illustrated embodiment, each local network interface aggregates received packets that were transmitted at 640 and stores the results of aggregated packets in local memories. In some embodiments, this utilized a group counter for received packets to determine when all packets to be aggregated have been received.

In some embodiments, the transmitting and aggregating of 640 and 650 are performed iteratively, e.g., using separate send and receive memory spaces to hide data transfer latency.

At 660, in the illustrated embodiment, each processing node performs one or more second local FFTs on the results stored in its respective local memory. This may generate an FFT result for the input sequence, where the result remains distributed across the local memories.

At 670, in the illustrated embodiment, the FFT result is provided based on the one or more second local FFTs. This may simply involve retaining the FFT result in the local memories or may involve aggregating and transmitting the FFT result.

In some embodiments, additional passes of performing local FFTs, sending, transmitting, and aggregating may be performed, as discussed above in the section regarding multi-pass techniques. In some embodiments, the number of passes for a given input sequence is determined such that the amount of data for each pass stored by each processing node is small enough to be stored in a low-level data cache. This may improve the efficiency of the FFT by avoiding cache thrashing, in some embodiments. In some embodiments, the computing system is configured to determine addresses for the registers in each memory 152 based on the number of passes and the size of the input sequence. In some embodiments, the method may include determining and storing the addresses stored in different ones of the plurality of registers in each of the network interfaces.

In various embodiments, using fine-grained packets for data transfer while communicating FFT results using larger packets may reduce latency of data transfer and allow processors actually performing transforms to be the critical path in performing an FFT.

Although the illustrated method is discussed in the context of an FFT, similar techniques for performing operations and scattering and gathering packets may be used for any of various operations or algorithms in addition to and/or in place of an FFT. FFTs are provided as one example algorithm but are not intended to limit the scope of the present disclosure. In various embodiments, one or more non-transitory computer readable media may store program instructions that are executable to perform any of the various techniques disclosed herein.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for performing a Fast Fourier Transform (FFT) using a system comprising a plurality of processing nodes, wherein each of the plurality of processing nodes includes a respective local memory and a respective local network interface (NI), wherein the plurality of processing nodes are configured to communicatively couple to a network via the NIs, the method comprising:
storing different portions of an input sequence for the FFT in the local memories such that the input sequence is distributed among the local memories;
performing, by each of the processing nodes, one or more first local FFTs on the portion of the input sequence stored in its respective local memory;
sending, by each of the processing nodes, results of the one or more first local FFTs to its respective local NI using first packets addressed to different ones of a plurality of registers included in the local NI;
transmitting, by each of the local NIs, the results of the one or more first local FFTs to remote NIs using second packets, wherein the second packets are addressed based on addresses stored in the different ones of the plurality of registers;
aggregating, by each of the local NIs, received packets addressed to the local NI by remote NIs and storing the results of the aggregated packets in the respective local memories;
performing, by each of the processing nodes, one or more second local FFTs on the results stored in its respective local memory; and
providing an FFT result based on the one or more second local FFTs.

2. The method of claim 1, further comprising:
assigning the first packets to transfer groups;
wherein the aggregating includes counting received packets for a given transfer group and performing the storing the results of the aggregated packets in response to receipt of a specified number of packets of a transfer group.

3. The method of claim 2, further comprising:
counting, by each of the processing nodes, a number of transfer groups received by the processing node, wherein the storing the results is performed to a location that is based on the counting.

4. The method of claim 1, further comprising:
transmitting, by each of the local NIs, the results of the one or more second local FFTs to remote NIs using third packets, wherein the third packets are addressed based on addresses stored in the different ones of the plurality of registers;
aggregating, by each of the local NIs, received ones of the third packets addressed to the local NI by remote NIs and storing the results of the aggregated third packets in the respective local memories; and
performing, by each of the processing nodes, one or more third local FFTs on the results stored in its respective local memory, after the storing the results of the aggregated third packets;
wherein the FFT result is further based on the one or more third local FFTs.

5. The method of claim 4, wherein the FFT result is a result for a two-dimensional FFT.

6. The method of claim 4, wherein the FFT result is a result for a multi-dimensional FFT having at least three dimensions.

7. The method of claim 1, wherein each of the local memories is a low-level cache.

8. The method of claim 7, further comprising:
performing the FFT using a plurality of passes of performing local FFTs, sending, transmitting, and aggregating; and
determining a number of the plurality of passes such that the amount of data for each pass stored by each processing node is small enough to be stored in the low-level cache.

9. The method of claim 1, further comprising:
iteratively performing the transmitting and aggregating a plurality of times, using the same addresses stored in the different ones of the plurality of registers for each iteration, wherein the storing the aggregated packets for each iteration is performed to a location that is determined based on a count of a current number of performed iterations.

10. The method of claim 1, further comprising:
determining and storing the addresses stored in the different ones of the plurality of registers in each of the NIs.

11. The method of claim 1, wherein each of the first packets includes data used as different payloads for multiple ones of the second packets.

12. The method of claim 11, wherein each of the first packets includes data from a cache line of one of the processing nodes and wherein each of the second packets includes data from an entry in a cache line.

13. A non-transitory computer-readable medium having instructions stored thereon that are executable to perform a Fast Fourier Transform (FFT) by a computing system that includes a plurality of processing nodes, wherein each of the plurality of processing nodes includes a respective local memory and a respective local network interface (NI), wherein the plurality of processing nodes are configured to communicatively couple to a network via the NIs, wherein the instructions are executable to perform operations comprising:
storing different portions of an input sequence for the FFT in the local memories such that the input sequence is distributed among the local memories;
performing, by each of the processing nodes, one or more first local FFTs on the portion of the input sequence stored in its respective local memory;
sending, by each of the processing nodes, results of the one or more first local FFTs to its respective local NI using first packets addressed to different ones of a plurality of registers included in the local NI;
transmitting, by each of the local NIs, the results of the one or more first local FFTs to remote NIs using second packets, wherein the second packets are addressed based on addresses stored in the different ones of the plurality of registers;
aggregating, by each of the local NIs, received packets addressed to the local NI by remote NIs and storing the results of the aggregated packets in the respective local memories;
performing, by each of the processing nodes, one or more second local FFTs on the results stored in its respective local memory; and
providing an FFT result based on the one or more second local FFTs.

14. The non-transitory computer-readable medium of claim 13, wherein the operations further comprise selecting performing the FFT using a plurality of passes of performing local FFTs, sending, transmitting, and aggregating; and
determining a number of the plurality of passes such that the amount of data for each pass stored by each local processing node is small enough to be stored in the low-level cache.

15. The non-transitory computer-readable medium of claim 13, wherein the FFT result is a result for a multi-dimensional FFT having at least three dimensions.

16. The non-transitory computer-readable medium of claim 13, wherein each of the first packets includes data used as different payloads for multiple ones of the second packets.

17. The non-transitory computer-readable medium of claim 13, wherein each of the first packets includes data from a cache line of one of the processing nodes and wherein each of the second packets includes data from an entry in a cache line.

18. The non-transitory computer-readable medium of claim 13, wherein the operations further comprise:
transmitting, by each of the local NIs, the results of the one or more second local FFTs to remote NIs using third packets, wherein the third packets are addressed based on addresses stored in the different ones of the plurality of registers;
aggregating, by each of the local NIs, received ones of the third packets addressed to the local NI by remote NIs and storing the results of the aggregated third packets in the respective local memories; and
performing, by each of the processing nodes, one or more third local FFTs on the results stored in its respective local memory, after the storing the results of the aggregated third packets;
wherein the FFT result is further based on the one or more third local FFTs.

19. A method for data processing using a system comprising a plurality of processing nodes, wherein each of the plurality of processing nodes includes a respective local memory and a respective local network interface (NI), wherein the plurality of processing nodes are configured to communicatively couple to a network via the NIs, the method comprising:
storing different portions of input data in the local memories such that the input data is distributed among the local memories;
performing, by each of the processing nodes, one or more first operations on at least a subset of the portion of the input data stored in its respective local memory;
sending, by each of the processing nodes, results of the one or more first operations to its respective local NI using first packets addressed to different ones of a plurality of registers included in the local NI;
transmitting, by each of the local NIs, the results of the one or more first operations to remote NIs using second packets, wherein the second packets are addressed based on addresses stored in the different ones of the plurality of registers;
aggregating, by each of the local NIs, received packets addressed to the local NI by remote NIs and storing the aggregated packets in the respective local memories; and
iteratively performing the transmitting and aggregating a plurality of times, using the same addresses stored in the different ones of the plurality of registers for each iteration, wherein the storing the aggregated packets for each iteration is performed to a location that is determined based on a count of a current number of performed iterations.

20. The method of claim 19, wherein a result of the iteratively performing is a Fast Fourier Transform (FFT) of the input data, the performing includes performing local transforms, and the transmitting and aggregating transpose results of the local transforms.
